(19) United States
(12) Patent Application Publication
(10) Pub. No.: US 2026/0278825 A1
(43) Pub. Date: Sep. 17, 2026

(54) METHOD, DEVICE, AND COMPUTER PROGRAM FOR THREE-DIMENSIONAL MEASUREMENTS IN A SKYBOX

(71) Applicant: Telefonaktiebolaget LM Ericsson (publ), Stockholm (SE)

(72) Inventors: Elijs DIMA, Upplands Väsby (SE); Volodya GRANCHAROV, Solna (SE); Sigurdur SVERRISSON, Kungsängen (SE); Vladislav POLIANSKII, Stockholm (SE); Tobias WIDMARK, Lund (SE)

(73) Assignee: Telefonaktiebolaget LM Ericsson (publ), Stockholm (SE)

(21) Appl. No.: 19/480,102

(22) PCT Filed: May 22, 2023
(86) PCT No.: PCT/EP2023/063650

§ 371 Date: Oct. 30, 2025

(51) Int. Cl. G06T 7/62; G06T 7/13

(52) U.S. Cl. CPC G06T 7/62; G06T 7/13; G06T 2207/10028; G06T 2207/20101

(57) ABSTRACT

There is provided techniques for 3D measurements in a skybox image rendering environment. The method is performed by a controller. The method comprises obtaining an indication for a 3D measurement to be made in the skybox image rendering environment. The method comprises identifying a start-point and an end-point in a panoramic image between which the 3D measurement extends by identifying opposite edges representing perimeters, or parts thereof, of the object. The method comprises determining a distance between the start-point and the end-point as a function of a first depth map corresponding to the start-point in the panoramic image and a second depth map corresponding to the end-point in the panoramic image.

### TECHNICAL FIELD

Embodiments presented herein relate to a method, a controller, a computer program, and a computer program product for three-dimensional (3D) measurements in a skybox image rendering environment.

### BACKGROUND

Digital twins, in the form of 3D models of objects of interest can be created from a scanned 3D point cloud of the object of interest. In this respect, in the process of 3D reconstruction, the scene geometry can be represented by a 3D point cloud. In this respect, a 3D point cloud, denoted Ω, can be regarded as an unstructured set of K points in the 3D space (with dimensions X, Y, Z)

$$Ω = {( {X}_{k} , {Y}_{k} , {Z}_{k} )}_{k = 1}^{K}$$

The 3D point cloud can be used to capture the scene geometry and scale, to thereby represent 3D structures from the physical world.

The process of creating a 3D point cloud of the physical environment generally comprises data acquisition and 3D reconstruction. In further detail, a 3D point cloud can be generated by means of passive (e.g., registering multiple two-dimensional (2D) images of the scene and estimating depth values by triangulation) or by active scanning (e.g., light detection and ranging (LIDAR), where the depth values are estimated by measuring the time-of-flight of emitted light).

Since the physical scene to be scanned could be large or have complex geometry, the scanning device is typically placed on a tripod where a scanning is performed. The scanning is then moved to a new location where a new scanning is performed. At each of these positions the scanning device spins around and performs a 360-degree scan of the environment. A scanning performed at one location is therefore referred to as a sweep. A sweep for a given location consists of a 3D point cloud generated from the given scanning location, the parameters for the given scanning location, and a set of 2D images collected at the given scanning location.

The point cloud could be explored by the user directly, using different types of software tools. However, it can be cumbersome for a user to navigate and perform measurements directly in a 3D point cloud. An alternative way of enabling navigation and measurements in a 3D reconstructed scene is to render a 2D panoramic image in a skybox image rendering environment based on the underlying 3D point cloud. In this approach the user is exposed to a panoramic image projected on the side of a cube (and hence the term skybox). In general terms, the source of a skybox can be any form of texture, including photographs, hand-drawn images, or pre-rendered 3D geometry. It is hereinafter assumed that the source of the skybox is a 3D point cloud, and that the 3D point cloud is projected as a panoramic image that is created and aligned in 6 directions, with viewing angles of 90 degrees (which covers the 6 faces of the cube). This can be achieved by cube mapping. In general terms, cube mapping is a technique to create pre-rendered panoramic sky images which are then rendered by a graphical engine as faces of a cube at practically infinite distance with the view point located in the center of the cube. One skybox is formed from a 2D panoramic image 110 obtained from the 3D point cloud of one sweep. In FIG. 1 is illustrated an example skybox image rendering environment composed of one skybox 100 (FIG. 1(a)), where one individual image I_{n,s}={I_{n,-90}, I_{n,0}, I_{n,+90}, I_{n,180}, I_{n,up}, I_{n,down}} of a 2D panoramic image 110 (FIG. 1(b)) is rendered on each side of the skybox 100.

Navigation in the 3D reconstructed scene is then enabled by letting the user move from one cube to another, which corresponds to jump from one sweep to another. Further, measurements are enabled by using a correspondence between the image pixels and the corresponding 3D points in the 3D point cloud.

In general terms, the user is expected to perform 3D measurement by manually clicking on pixels in the scene, designating a start-point and an end-point. The system then calculates the real-world distance between these points using the underlying point cloud. In this way the user thus can perform measurements in the scene by clicking on pixels, but where the actual dimensions, or distances, are calculated based on the underlying 3D point cloud. That is, the actual measurements are made on the 3D point cloud (i.e., between points in 3D space), for which depth information is required.

One issue with existing techniques for 3D measurement in a skybox image rendering environment is that the accuracy of the measurements is dependent on the user's accuracy when clicking on the pixels to determine the start-point and the end-point.

Hence, there is still a need for improved 3D measurement in a skybox image rendering environment.

### SUMMARY

An object of embodiments herein is to enable 3D measurements to be made in a skybox mage rendering environment without suffering from the above issues.

A particular object is to enable 3D measurements to be made in a skybox image rendering environment that do not depend on the user's accuracy of selecting proper start-points and end-points for the 3D measurements.

According to a first aspect there is presented a method for 3D measurements in a skybox image rendering environment. The method is performed by a controller. The method comprises obtaining an indication for a 3D measurement to be made in the skybox image rendering environment. The indication specifies an object depicted in a 2D panoramic image as rendered in the skybox image rendering environment. The indication specifies a measurement direction. The method comprises identifying a start-point and an end-point in the panoramic image between which the 3D measurement extends by identifying opposite edges representing perimeters, or parts thereof, of the object. The opposite edges are identified by starting from an initial point in the 2D panoramic image located inside the object and searching in a first direction along the measurement direction until encountering a first point on a first edge of the object and searching in a second direction opposite the measurement direction until encountering a second point on a second edge of the object. The first point defines the end-point and the second point defines the start-point. The method comprises determining a distance between the start-point and the end-point as a function of a first depth map corresponding to the start-point in the panoramic image and a second depth map corresponding to the end-point in the panoramic image.

According to a second aspect there is presented a controller for 3D measurements in a skybox image rendering environment. The controller comprises processing circuitry. The processing circuitry is configured to cause the controller to obtain an indication for a 3D measurement to be made in the skybox image rendering environment. The indication specifies an object depicted in a 2D panoramic image as rendered in the skybox image rendering environment. The indication specifies a measurement direction. The processing circuitry is configured to cause the controller to identify a start-point and an end-point in the panoramic image between which the 3D measurement extends by identifying opposite edges representing perimeters, or parts thereof, of the object. The opposite edges are identified by starting from an initial point in the 2D panoramic image located inside the object and searching in a first direction along the measurement direction until encountering a first point on a first edge of the object and searching in a second direction opposite the measurement direction until encountering a second point on a second edge of the object. The first point defines the end-point and the second point defines the start-point. The processing circuitry is configured to cause the controller to determine a distance between the start-point and the end-point as a function of a first depth map corresponding to the start-point in the panoramic image and a second depth map corresponding to the end-point in the panoramic image.

According to a third aspect there is presented a controller for 3D measurements in a skybox image rendering environment. The controller comprises an obtain module configured to obtain an indication for a 3D measurement to be made in the skybox image rendering environment. The indication specifies an object depicted in a 2D panoramic image as rendered in the skybox image rendering environment. The indication specifies a measurement direction. The controller comprises an identify module configured to identify a start-point and an end-point in the panoramic image between which the 3D measurement extends by identifying opposite edges representing perimeters, or parts thereof, of the object. The opposite edges are identified by starting from an initial point in the 2D panoramic image located inside the object and searching in a first direction along the measurement direction until encountering a first point on a first edge of the object and searching in a second direction opposite the measurement direction until encountering a second point on a second edge of the object. The first point defines the end-point and the second point defines the start-point. The controller comprises a determine module configured to determine a distance between the start-point and the end-point as a function of a first depth map corresponding to the start-point in the panoramic image and a second depth map corresponding to the end-point in the panoramic image.

According to a fourth aspect there is presented a computer program for 3D measurements in a skybox image rendering environment. The computer program comprises computer code which, when run on processing circuitry of a controller, causes the controller to perform actions. One action comprises the controller to obtain an indication for a 3D measurement to be made in the skybox image rendering environment. The indication specifies an object depicted in a 2D panoramic image as rendered in the skybox image rendering environment. The indication specifies a measurement direction. One action comprises the controller to identify a start-point and an end-point in the panoramic image between which the 3D measurement extends by identifying opposite edges representing perimeters, or parts thereof, of the object. The opposite edges are identified by starting from an initial point in the 2D panoramic image located inside the object and searching in a first direction along the measurement direction until encountering a first point on a first edge of the object and searching in a second direction opposite the measurement direction until encountering a second point on a second edge of the object. The first point defines the end-point and the second point defines the start-point. One action comprises the controller to determine a distance between the start-point and the end-point as a function of a first depth map corresponding to the start-point in the panoramic image and a second depth map corresponding to the end-point in the panoramic image.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable more accurate 3D measurement to be made in a skybox image rendering environment.

Advantageously, these aspects enable 3D measurements to be made in a skybox image rendering environment that do not depend on the user's accuracy of selecting proper start-points and end-points for the 3D measurements.

Advantageously, these aspects ensure that 3D measurements are performed edge-to-edge, thus preventing the use of measurement end-points placed inside the object before the edge as well as measurement end-points placed outside the object beyond the edge, which would yield incorrect measurement results.

Advantageously, these aspects ensure that the alignment of the measurement end-points is accurate.

Advantageously, these aspects reduce the number of steps needed from the user to perform the 3D measurement, by allowing a single-click initiation and removing the need for the user to manually refine the end-point positions.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a skybox image rendering environment and a panoramic image according to an example;

FIG. 2 schematically illustrates a system according to an embodiment;

FIG. 3 is a block diagram of a controller according to an embodiment;

FIG. 4 is a flowchart of methods according to embodiments;

FIG. 5 shows a sequence of illustrations according to an embodiment;

FIG. 6 schematically illustrates how to establish horizontal and vertical offset angles according to an embodiment;

FIG. 7 schematically illustrates how to determine a step-point for a marching-ray iteration according to an embodiment;

FIG. 8 schematically illustrates a marching ray iteration between the positions of two points according to an embodiment;

FIG. 9 and FIG. 10 schematically illustrate a 3D measurement process according to embodiments;

FIG. 11 is a schematic diagram showing functional units of a controller according to an embodiment;

FIG. 12 is a schematic diagram showing functional modules of a controller according to an embodiment; and

FIG. 13 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, the accuracy of the measurements is dependent on the user's accuracy when clicking on the pixels to determine the start-point and the end-point.

In further detail, in general terms, there are two issues related to the outlined above manual procedure of initiating 3D measurement. Both issues are caused by the reliance on the accuracy of at which pixels the user clicks to determine the start-point and end-point of a 3D measurement.

Firstly, when a user wants to measure some property of an object (such as size, height, width, etc.), this commonly involves a measurement to be made from one edge of the object to an opposing edge. Hence, measurements are seldomly made between two points randomly placed on the surface of the object. This means that the user must be extra careful to click on a pixel representing the object's edge; i.e., neither inside the object, nor beyond the edge at the outside of the object as this might significantly change the depth of the end-points and affect the measurement accuracy. That is why users are typically required to perform several clicks, or point repositioning, zooming the view, etc., all of which are time-consuming and none of which guarantees that an edge indeed is selected.

Secondly, when reference measurements for Building Information Modeling (BIM) or Computer Aided Design (CAD) modelling are to be performed, the object's size along horizontal and vertical directions (i.e., “height” and “width”) are commonly desired. With manually entered end-points, at worst, the user has no guarantee or even indication if the end-points actually yield horizontal (or vertical) measurements. This will lead to erroneous measurements.

Both of these issues can lead to errors in the measurements

The embodiments disclosed herein therefore relate to techniques for 3D measurements in a skybox image rendering environment 100. In order to obtain such techniques there is provided a controller 210, 300, 1100, 1200, a method performed by the controller 210, 300, 1100, 1200, a computer program product comprising code, for example in the form of a computer program, that when run on a controller 210, 300, 1100, 1200, causes the controller 210, 300, 1100, 1200 to perform the method.

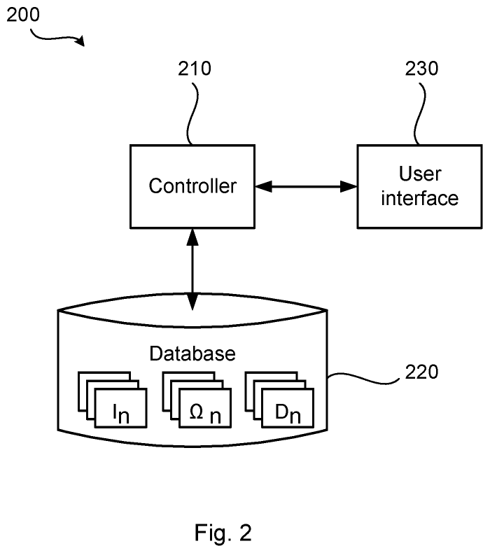

In FIG. 2 is illustrated a system 200 comprising a controller 210, a database 220, and a user interface 230. The database 220 stores N panoramic images Iₙ, 3D point clouds Ωₙ, and depth maps Dₙ. The controller 210 is configured to interact with the user interface 230 and with the database 220. Iₙ general terms, the controller 210 is configured to facilitate improved 3D measurements in a skybox image rendering environment 100 by identifying end-points in the panoramic image 110 between which the 3D measurement extends

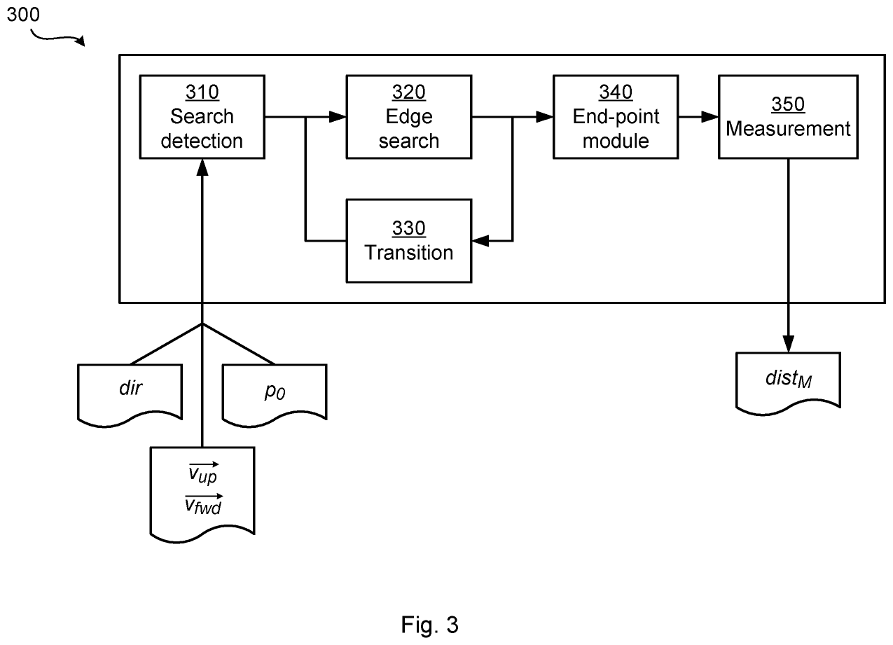

Further details of the controller will be disclosed next with reference to the block diagram of FIG. 3. The controller 300 takes as input a measurement direction dir for the 3D measurement. In some examples, the controller 300 further takes as input any, or any combination, of an initial point pₒ for the measurement a default up-vector \vec{vᵤₚ}, a camera viewing direction \vec{v_{fwd}}, one or more depth maps D, one or more edge maps E. The controller 300 provides as output a resulting measured distance dist_{M}.

The initial point po lies on the image plane in one of the six cube map images (Iₘ) in the skybox image rendering environment 100. This point denotes the starting location of the measurement process in pixel coordinates. The measurement direction dir constrains the search for measurement end-points. The default up-vector \vec{vᵤₚ} is provided by the underlying pointcloud Ω and/or the rendering camera, and the camera viewing direction \vec{v_{fwd}}. The depth map Dm, generated from the underlying pointcloud Ω, contains the distances associated with each pixel of the cube map image Iₘ. The edge-map Eₘ, generated from the cube map image Iₘ, is the edge map associated with the depth map Dₘ.

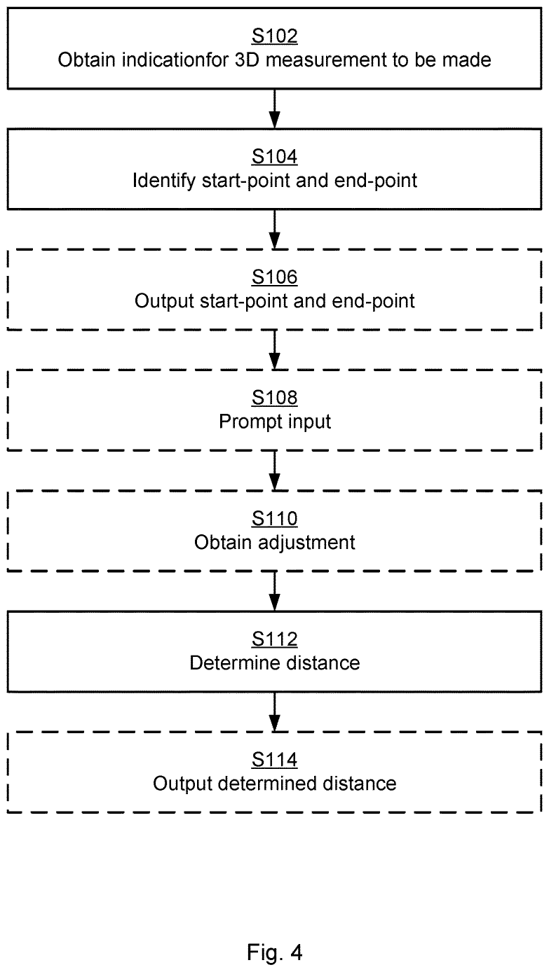

The controller 300 comprises modules. Further details of these modules will be disclosed next. A search detection module is configured to obtain an indication for a 3D measurement to be made in the skybox image rendering environment 100. The indication specifies an object depicted in a 2D panoramic image 110 as rendered in the skybox image rendering environment 100. The indication specifies at least one measurement direction, dir. An edge search module is configured to search for edges representing perimeters, or parts thereof, of the object. A transition module is configured to provide a transition between different cube map images, if needed. An end-point module is configured to identify a start-point M₁ and an end-point M₂ in the panoramic image 110 between which the 3D measurement extends. A measurement module is configured to determine the distance dist_{M} between the start-point M₁ and the end-point M₂. Further details of the operation of the controller will be disclosed next with reference to FIG. 4.

FIG. 4 is a flowchart illustrating embodiments of methods for 3D measurements in a skybox image rendering environment 100. The methods are performed by the controller 210, 300, 1100, 1200. The methods are advantageously provided as computer programs 1320.

The skybox image rendering environment 100 exposes the ability for the user to inspect and perform point-to-point measurements. The skybox image rendering environment 100 also exposes an option for the user to select a single origin point pₒ in any image I_{m,side} of any skybox m and request the controller 210, 300, 1100, 1200 to perform 3D measurements around the specified point.

S102: The controller 210, 300, 1100, 1200 obtains an indication for a 3D measurement to be made in the skybox image rendering environment 100.

The indication specifies an object (e.g., in terms of pointing at a pixel belonging to the object) depicted in a 2D panoramic image 110 as rendered in the skybox image rendering environment 100. The indication specifies at least one measurement direction, dir.

S104: The controller 210, 300, 1100, 1200 identifies a start-point M₁ and an end-point M₂ in the panoramic image 110 between which the 3D measurement extends. The start-point M₁ and the end-point M₂ are identified by the controller 210, 300, 1100, 1200 identifying opposite edges representing perimeters (or boundaries), or parts thereof, of the object.

The opposite edges are identified by starting from an initial point in the 2D panoramic image 110 located inside the object and then searching in a first direction along the measurement direction until encountering a first point on a first edge of the object and by searching in a second direction opposite the measurement direction until encountering a second point on a second edge of the object. Then, the first point defines the end-point M₂ and the second point defines the start-point M₁.

This enables the start-point M₁ and the end-point M₂ for the 3D measurement to, from a single user input, be estimated based on the underlying geometry (i.e., point cloud) of the scene.

Once the controller 210, 300, 1100, 1200 has identified the start-point M₁ and the end-point M₂, these end-points might in some optional embodiments be presented to the user, for example for approval or refinement. Details regarding this will be disclosed below. In other embodiments the controller 210, 300, 1100, 1200 directly proceeds to calculating the distances between the estimated end-points.

S112: The controller 210, 300, 1100, 1200 determines a distance dist_{M} between the start-point M₁ and the end-point M₂ as a function of a first depth map and a second depth map. The first depth map corresponds to the start-point M₁ in the panoramic image 110. The second depth map corresponds to the end-point M₂ in the panoramic image 110.

The controller 210, 300, 1100, 1200 might then, in some optional embodiments, display the measured distance to the user. Details regarding this will be disclosed below.

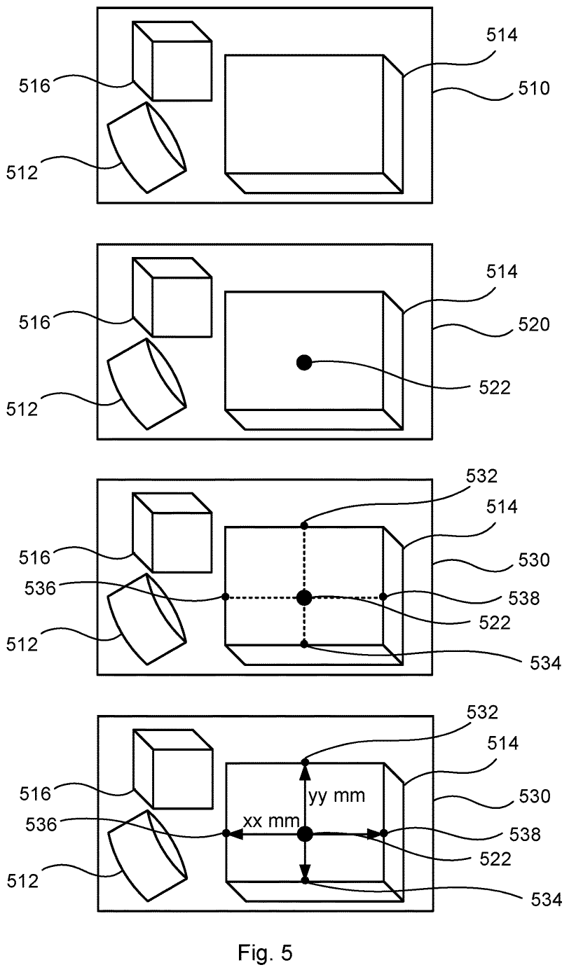

Intermediate reference is here made to FIG. 5 which shows a sequence of illustrations to illustrate the main inventive concept as described thus far. At 510 is illustrated a 2D panoramic image comprising three objects; a cylinder 512, a rectangular block 514, and a cube 516. At 520 is illustrated that one of the objects (the rectangular block 514) has been marked with a black dot 522. This is an indication that specifies that 3D measurements of the object are to be made. In the illustrative example, it is assumed that both vertical and horizontal measurements are to be made. At 530 is illustrated that four points 532, 534, 536, 538, each laying on a respective edge of the identified object, have been identified. Two of the points 532, 534 are the end-points of a vertical measurement and the other two of the points 536, 538 are the end-points of a horizontal measurement. At 540 is illustrated that the determined vertical distance (expressed as “yy mm”) and the determined horizontal distance (expressed as “xx mm”).

Embodiments relating to further details of 3D measurements in a skybox image rendering environment 100 as performed by the controller 210, 300, 1100, 1200 will now be disclosed with continued reference to FIG. 4.

In some embodiments, the skybox image rendering environment 100 is obtained from a 3D point cloud. The depth maps could then be generated from the 3D point cloud.

In some aspects, input, for example in terms of the user clicking on a pixel, that defines a user-designated point pₒ inside the object is received. This initial point pₒ can be expressed as a 2D coordinate in the image plane of I_{m,s}. Hence, in some embodiments, the initial point in the 2D panoramic image 110 is expressed as a coordinate in the 2D panoramic image 110 and is given by the indication for the 3D measurement.

Further aspects of identifying the start-point M₁ and the end-point M₂ in the panoramic image 110 will be disclosed next.

As disclosed above, identifying the opposite edges involves searching in a first direction along the measurement direction and searching in a second direction opposite the measurement direction. In some aspects, the directions for the measurement are established from the underlying point cloud and/or the rendering camera axes. Therefore, in some embodiments, the first direction and the second direction are established from directional vectors in the 3D point cloud and/or directional vectors in the skybox image rendering environment 100.

As disclosed above, the indication specifies at least one measurement direction, dir. There could be different such measurement directions. In some non-limiting examples, the measurement direction is any of: horizontal, vertical, user-defined. Further in this respects, two measurement directions are indicated. That is, in some embodiments, the indication specifies two measurement directions, and each of the two measurement directions is associated with its own pair of one start-point and one end-point. An initial measurement point could then be indicated, denoting the intersection of the two measurement directions. There are then four edges of the object that define measurement end-points. In some non-limiting examples, the first measurement direction and the second measurement direction are perpendicular to each other. For example, the first measurement direction might be horizontal whereas the second measurement direction is vertical (or vice versa). However, in other examples, the measurement directions are offset from being horizontal and vertical. For example, the measurement direction might be indicated as coinciding with the diagonals of the object.

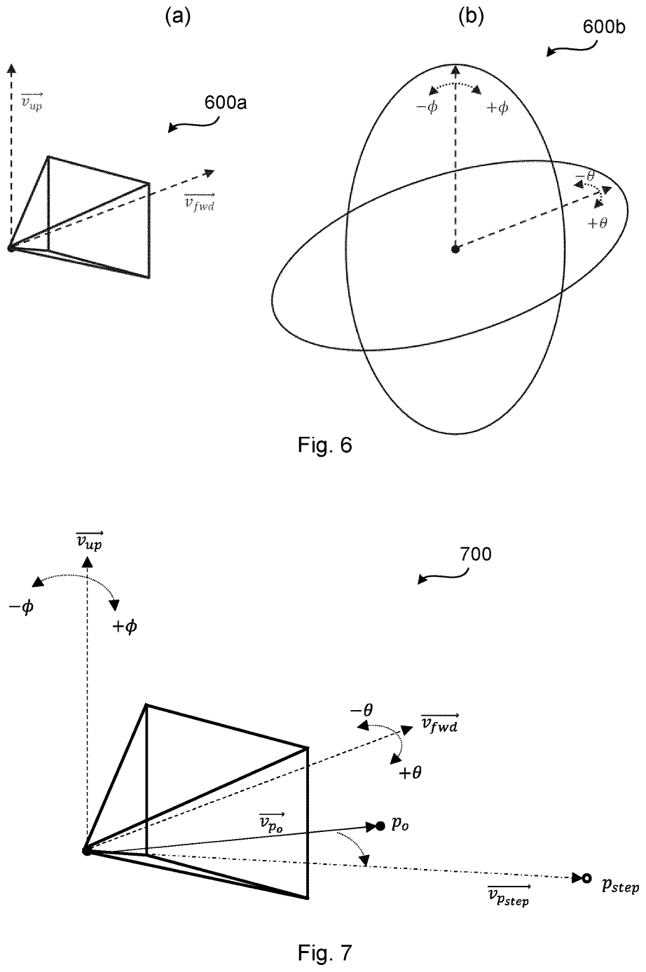

As an illustrative example, the set of measurement directions dir can be {up, down} in case the indication specifies the measurement direction to be vertical, the set of measurement directions dir can be {left, right} in case the indication specifies the measurement direction to be horizontal, and the set of measurement directions dir can be {up, down, left, right} in case the indication specifies the two measurement directions; vertical and horizontal. These measurement directions can be expressed as changes in latitude and longitude angles (θ, φ) with respect to a default up-vector \vec{vᵤₚ} and a default forward-vector \vec{v_{fwd}} of the underlying point cloud. That is, in some embodiments, the first direction and the second direction represent changes in latitude and longitude angles with respect to a default vertically pointing vector and a default horizontally pointing vector in the 3D point cloud. These vectors might correspond to the default up-vector and forward-vector of the virtual camera used for skybox view rendering, as illustrated in FIG. 6. Iₙ FIG. 6 is illustrated an example of how to establish horizontal and vertical offset angles (θ and φ, respectively) based on the default camera up (\vec{vᵤₚ}) and forward (\vec{v_{fwd}}) vectors illustrated at reference numeral 600a in FIG. 6(a). As illustrated at reference numeral 600b in FIG. 6(b), in the skybox image rendering environment, these default vectors are by means of φ and θ matched to the up and forward alignment of the underlying point cloud.

For each measurement direction as specified by dir, an end-point search process is performed for identifying the opposite edges. In some aspects, the end-point search process involves determining a parsing direction, and then performing an edge search. Here, the parsing direction is the same as given by the measurement direction as specified by dir. Hence, in some embodiments, searching in the first direction and searching in the second direction involves establishing a respective parsing direction and performing an edge search along each respective parsing direction.

In general terms, the parsing direction specifies a direction from the point pₒ to a step-point pₛₜₑₚ, as illustrated in FIG. 7. In FIG. 7 is at reference numeral 700 illustrated an example of how the step-point pₛₜₑₚ (illustrated as a vector \vec{pₛₜₑₚ} in FIG. 7) for the marching-ray iteration can be determined from the initial point pₒ in the {right} direction, by rotating the vector \vec{vₚ_{ₒ}} by n degrees in direction θ and by rotating the vector \vec{vₚ_{ₒ}} by 0 degrees in direction φ. The values of the offsets θ, φ with respect to \vec{vᵤₚ} and \vec{v_{fwd}} are established as shown in FIG. 6. Hence, in some embodiments, the parsing direction is established by starting from the initial point in the 2D panoramic image 110 to a step-point.

In some aspects, the step point pₛₜₑₚ is estimated by taking the ray \vec{vₚ_{ₒ}} from the camera center to pₒ and rotating it by n(θ, φ), where n is step size in degrees and (θ, φ) are set based on the measurement direction dir. An illustrative example for setting (θ, φ) according to different examples of measurement direction as specified by dir is given in Table 1.

TABLE 1
Examples of (θ, φ) for different values of dir.

| dir | {up} | {down} | {left} | {right} |
|---|---|---|---|---|
| θ | 0 | 0 | −1 | 1 |
| φ | 1 | −1 | 0 | 0 |

In some examples, the measurement direction dir is mapped on an additional offset of the angles (θ, φ) based on user input. This offset (θᵤₛₑᵣ, φᵤₛₑᵣ) can be set by the user and allows for 3D measurement along directions that are neither horizontal nor vertical.

The rotated ray \vec{vₚ_{ₛₜₑₚ}} is raycast into the image plane of I_{m,s} to determine the pixel coordinate of pₛₜₑₚ; this gives the parsing direction of pₒ→pₛₜₑₚ.

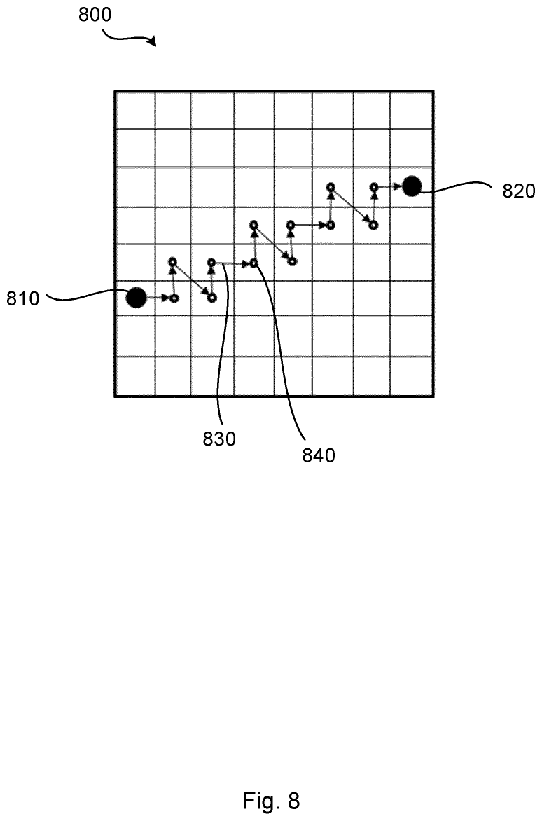

The edge search is performed in the edge map E_{m,s} from pₒ to pₛₜₑₚ using marching ray iteration across the 2D image pixel grid. One example of a process to calculate the missing depth values will be disclosed next with reference to FIG. 8. In FIG. 8 is provided an illustration 800 of a marching ray iteration between the positions of two points; a start-point 810 and an end-point 820. Hollow circles 840 represent all coordinates inspected during the marching ray iteration along the path from point to point as given by arrow 830. According to the embodiments disclosed herein, the marching ray iteration is used to search for whether there is an edge between the two end-point positions. Hence, in some embodiments, the edge search is performed in an edge map by using marching-ray iteration across a 2D image pixel grid of the 2D panoramic image 110.

In general terms, the edge map E_{m,s} is a binary mask containing edges (as nonzero-values) corresponding to the image I_{m,s} and the associated depth map D_{m,s}. If a nonzero-value is found in the binary mask, the position of that nonzero-value is denoted as the end-point location. That is, in some embodiments, the edge map is a binary mask containing nonzero-values corresponding to edges in the 2D panoramic image 110 and zero-values corresponding to non-edges in the 2D panoramic image 110. The edge map E_{m,s} can be generated ahead-of-time from I_{m,s} or the associated depth map D_{m,s} or any combination thereof. In some examples, the edge map E_{m,s} can also be a composite of several distinct binary maps representing object edges and other boundaries generated from the images Iₘ and the underlying point cloud Ω. In some examples, the edge map generating function is run when the measurement is to be made (e.g., at marching time) and not ahead-of-time from the measurement-relevant areas of the image and/or depth map. That is, the edge map may be implicit rather than explicit.

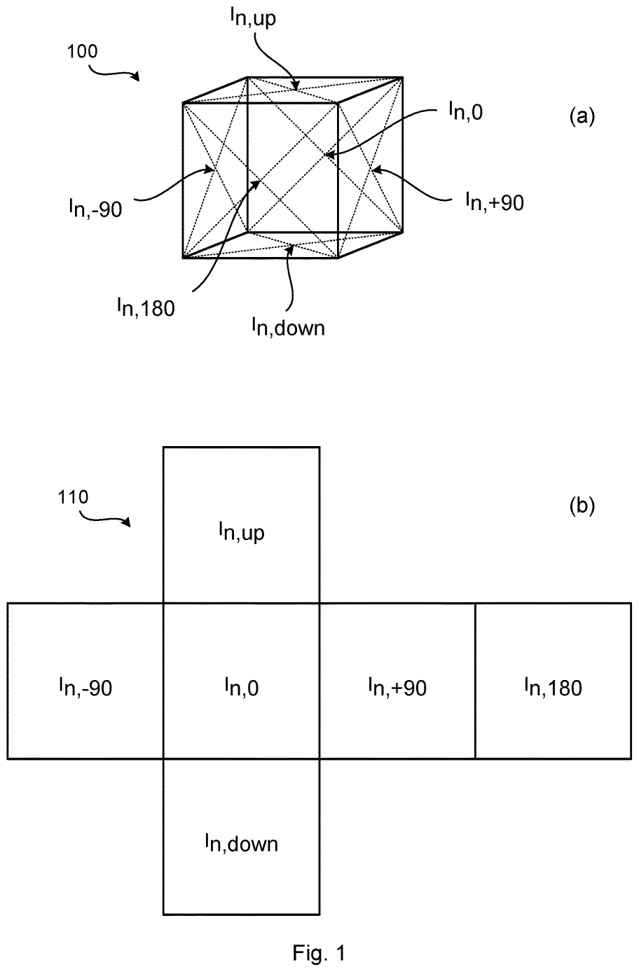

During the marching ray iteration from pₒ to pₛₜₑₚ, if a nonzero-value is found in the edge map E_{m,s}, the position of that nonzero-value is denoted as the end-point location. If a nonzero-value is not found on the path, then the marching process is repeated from pₛₜₑₚ to pₛₜₑₚ₂ in the same way as was done from pₒ to pₛₜₑₚ. This is done until a nonzero-value is found in the edge map E_{m,s}, or until another boundary condition is met. Possible boundary conditions are: exceeding an angular threshold nₘₐₓ when estimating step size via n(θ, φ); exceeding a full rotation; exceeding camera field of view. Reaching the border of E_{m,s} is not a boundary condition. In case a border of E_{m,s} is reached whilst the marching ray iteration is performed, an adjacent edge map E_{m,s+} is loaded based on the layout of the cube map sides, see FIG. 1.

In this way, for each of the requested measurement direction dir, either a suitable end-point is found or a boundary condition is reached.

As noted above, the end-points might in some optional embodiments be presented to the user, for example for approval or refinement. Hence, the controller 210, 300, 1100, 1200 might be configured to perform (optional) step S106.

S106: The controller 210, 300, 1100, 1200 outputs the identified start-point M₁ and end-point M₂ before retrieving the first depth map and the second depth map.

In case a boundary condition is reached in a direction without encountering an edge (i.e., no appropriate end-point is found), the user might be notified. Optionally, the measurement in the affected direction pair can be skipped. Alternatively, if in a given direction pair (horizontal or vertical) only one end-point is found (instead of two), the measurement can be performed using the initial point p, in place of the missing end-point and the user may be notified.

If all needed end-points are found (or if a missing end-point is substituted by the original user-designated point pₒ), the controller might present the end-points to the user for approval and/or finetuning. Hence, in some embodiments, the controller 210, 300, 1100, 1200 is configured to perform (optional) step S108 and/or step S110.

S108: The controller 210, 300, 1100, 1200 prompts input for acceptance of the identified start-point M₁ and end-point M₂ before retrieving the first depth map and the second depth map.

S110: The controller 210, 300, 1100, 1200 obtains adjustment to at least one of the identified start-point M₁ and end-point M₂. The first depth map and the second depth map are retrieved for the identified start-point M₁ and end-point M₂ as adjusted.

Further aspects of determining the distance dist_{M} between the start-point M₁ and the end-point M₂ as a function of the first depth map and the second depth map will be disclosed next.

In general terms, the panoramic image 110 might be composed of a set of individual images I_{n,s}={I_{n,-90}, I_{n,0}, I_{n,+90}, I_{n,180}, I_{n,up}, I_{n,down}}, with one individual image per each side in the skybox image rendering environment 100, and there is one depth map per each individual image.

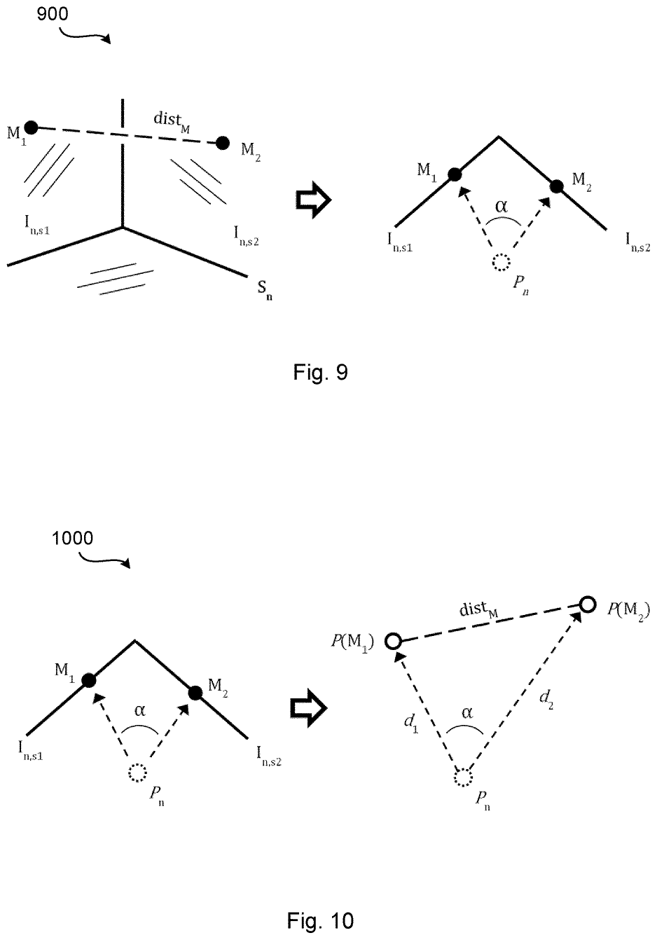

When two end-points of a 3D measurement are given (i.e., a start-point M₁ and an end-point M₂), the 3D measurement process can begin. The process is illustrated in FIG. 9 and in FIG. 10, showing at reference numeral 900 the start-point M₁ and an end-point M₂ on images I_{n,s1}, I_{n,s2} and at reference numeral 1000 calculation of the distance dist_{M} between the start-point M₁ and the end-point M₂. In particular, in FIG. 9 is illustrated a process for performing 3D measurement for a distance between two specified end-points; M₁ and M₂. The left side shows a skybox Sₙ with images I_{n,s1} and I_{n,s2} on the skybox sides. On each side-image is a specified end-point (illustrated by black dots marked by M₁, M₂), and the desired measurement is dist_{M} (dashed line between the dots). The right side shows the same concept from above; two images (I_{n,s1}, I_{n,s2}) with two specified end-points (M₁, M₂). The skybox centre is at point pₙ, and the angle between lines M₁←pₙ and M₁←pₙ is alpha (α). The angle α is calculated between the start-point M₁ and the end point M₂ on the skybox, using the skybox centre pₙ as the apex (see, FIG. 9). Specifically, the angle α is calculated between the line l_{centre,start} connecting the skybox centre pₙ to the start-point M₁, and the line l_{centre,end} connecting the skybox centre pₙ to the end-point M₂, as follows:

$$α = {cos}^{- 1} ( \frac{{l}_{centre , start} \cdot {l}_{centre , end}}{\vert {l}_{centre , start} \vert \vert {l}_{centre , end} \vert} ) .$$

FIG. 10 illustrates continuation of the process in FIG. 9. The left side shows two images (I_{n,s1}, I_{n,s2}) with two specified end-points (M₁, M₂). The skybox centre is at point pₙ, and the angle between lines M₁←pₙ and M₁←pₙ is alpha (α). The right side shows how the end-point M₁ is implicitly extended to a point p(M₁), using the distance d₁ from the depth map associated with image I_{n,s1}. Likewise, the end-point M₂ is implicitly extended to point p(M₂), using distance d₂ from the depth map associated with image I_{n,s2}. The desired distance dist_{M} is calculated as the distance between the implicit points p(M₁), p(M₂), using the angle α and distances d₁, d₂. The distance d₁ between the skybox centre pₙ and the start-point M₁ and the distance d₂ between the skybox centre pₙ and the end-point M₂ are read from the reduced depth maps D_{1,e} and D_{2,e}. Since D_{n,e} has the same resolution as I_{n,s}, the selection of a point (as a 2D pixel) in I_{n,s} also gives the selection of the appropriate depth value in D_{n,e}. The 3D measurement dist_{M} is then calculated using α and d₁, d₂ as follows:

$${dist}_{M} = \sqrt{{d}_{1}^{2} + {d}_{2}^{2} - 2 {d}_{1} {d}_{2} cos α} .$$

As illustrated in FIGS. 9 and 10, the start-point and the end point do not need to be on the same image, but they do need to be in the same skybox. The associated reduced depth maps D_{1,e} and D_{2,e} are retrieved. If the start-point and the end points are in the same cube map side image (I_{m,s1}), only one associated depth map (D_{m,s1}) is needed.

In some examples, the set of cube map images Iₘ and the depth map images Dₘ do not have a 1:1 correlation in pixel resolution. This could be when the equipment used to create the image sets is unable to provide them in the same resolution (e.g., different camera resolution for RGB and depth images). Iₙ such cases, whenever a point's pixel coordinates obtained from one image is used to determine the pixel coordinates in another image (such as when determining the depth values d₁, d₂ of M₁, M₂), the coordinates are scaled to match the position intended in the original image.

The value of dist_{M} can be output from the controller 210, 300, 1100, 1200. Therefore, in some embodiments, the controller 210, 300, 1100, 1200 is configured to perform (optional) step S114.

S114: The controller 210, 300, 1100, 1200 outputs the determined distance dist_{M}.

There can different ways in which the determined distance dist_{M} is output.

Iₙ some aspects, the determined distance dist_{M} is displayed to the user on the user interface 230, for example as an overlay in the skybox image rendering environment 100. Hence, in some embodiments, the determined distance dist_{M} is output by being provided to a user interface 230 for being displayed to a user.

In some aspects, the determined distance dist_{M} is exported for use by another application function (such as a BIM or CAD application). Hence, in some embodiments, the determined distance dist_{M} is output by being provided to an interface of a computer-implemented image processing application.

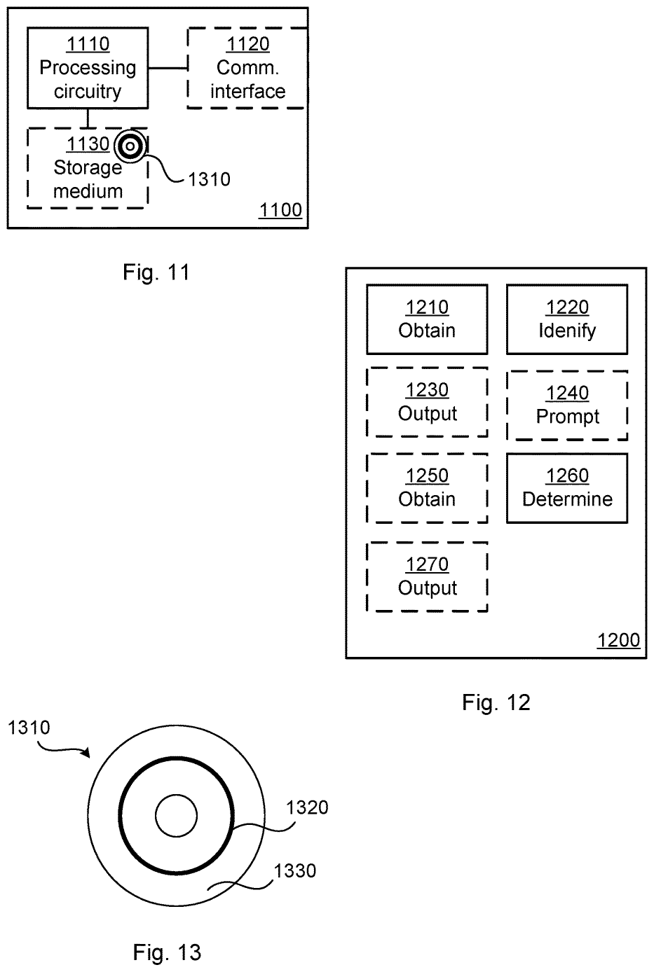

FIG. 11 schematically illustrates, in terms of a number of functional units, the components of a controller 1100 according to an embodiment. Processing circuitry 1110 is provided using any combination of one or more of a suitable central processing unit (CPU), multiprocessor, microcontroller, digital signal processor (DSP), etc., capable of executing software instructions stored in a computer program product 1310 (as in FIG. 13), e.g. in the form of a storage medium 1130. The processing circuitry 1110 may further be provided as at least one application specific integrated circuit (ASIC), or field programmable gate array (FPGA).

Particularly, the processing circuitry 1110 is configured to cause the controller 1100 to perform a set of operations, or steps, as disclosed above. For example, the storage medium 1130 may store the set of operations, and the processing circuitry 1110 may be configured to retrieve the set of operations from the storage medium 1130 to cause the controller 1100 to perform the set of operations. The set of operations may be provided as a set of executable instructions.

Thus the processing circuitry 1110 is thereby arranged to execute methods as herein disclosed. The storage medium 1130 may also comprise persistent storage, which, for example, can be any single one or combination of magnetic memory, optical memory, solid state memory or even remotely mounted memory. The controller 1100 may further comprise a communications (comm.) interface 1120 at least configured for communications with other entities, functions, nodes, and devices, as in FIG. 2. As such the communications interface 1120 may comprise one or more transmitters and receivers, comprising analogue and digital components. The processing circuitry 1110 controls the general operation of the controller 1100 e.g. by sending data and control signals to the communications interface 1120 and the storage medium 1130, by receiving data and reports from the communications interface 1120, and by retrieving data and instructions from the storage medium 1130. Other components, as well as the related functionality, of the controller 1100 are omitted in order not to obscure the concepts presented herein.

FIG. 12 schematically illustrates, in terms of a number of functional modules, the components of a controller 1200 according to an embodiment. The controller 1200 of FIG. 12 comprises a number of functional modules; an obtain module 1210 configured to perform step S102, an identify module 1220 configured to perform step S104, and a determine module 1260 configured to perform step S112. The controller 1200 of FIG. 12 may further comprise a number of optional functional modules, such as any of an output module 1230 configured to perform step S106, a prompt module 1240 configured to perform step S108, an obtain module 1250 configured to perform step S110, an output module 1270 configured to perform step S114.

In general terms, each functional module 1210:1270 may in one embodiment be implemented only in hardware and in another embodiment with the help of software, i.e., the latter embodiment having computer program instructions stored on the storage medium 1130 which when run on the processing circuitry makes the controller 1100 perform the corresponding steps mentioned above in conjunction with FIG. 12. It should also be mentioned that even though the modules correspond to parts of a computer program, they do not need to be separate modules therein, but the way in which they are implemented in software is dependent on the programming language used. Preferably, one or more or all functional modules 1210:1270 may be implemented by the processing circuitry 1110, possibly in cooperation with the communications interface 1120 and/or the storage medium 1130. The processing circuitry 1110 may thus be configured to from the storage medium 1130 fetch instructions as provided by a functional module 1210:1270 and to execute these instructions, thereby performing any steps as disclosed herein.

The controller 210, 300, 1100, 1200 may be provided as a standalone device or as a part of at least one further device. A first portion of the instructions performed by the controller 210, 300, 1100, 1200 may be executed in a first device, and a second portion of the of the instructions performed by the controller 210, 300, 1100, 1200 may be executed in a second device; the herein disclosed embodiments are not limited to any particular number of devices on which the instructions performed by the controller 210, 300, 1100, 1200 may be executed. Hence, the methods according to the herein disclosed embodiments are suitable to be performed by a controller 210, 300, 1100, 1200 residing in a cloud computational environment. Therefore, although a single processing circuitry 1110 is illustrated in FIG. 11 the processing circuitry 1110 may be distributed among a plurality of devices, or nodes. The same applies to the functional modules 1210:1270 of FIG. 12 and the computer program 1320 of FIG. 13.

FIG. 13 shows one example of a computer program product 1310 comprising computer readable storage medium 1330. On this computer readable storage medium 1330, a computer program 1320 can be stored, which computer program 1320 can cause the processing circuitry 1110 and thereto operatively coupled entities and devices, such as the communications interface 1120 and the storage medium 1130, to execute methods according to embodiments described herein. The computer program 1320 and/or computer program product 1310 may thus provide means for performing any steps as herein disclosed.

In the example of FIG. 13, the computer program product 1310 is illustrated as an optical disc, such as a CD (compact disc) or a DVD (digital versatile disc) or a Blu-Ray disc. The computer program product 1310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320 is here schematically shown as a track on the depicted optical disk, the computer program 1320 can be stored in any way which is suitable for the computer program product 1310.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for three-dimensional (3D) measurements in a skybox image rendering environment, the method being performed by a controller, the method comprising:
obtaining an indication for a 3D measurement to be made in the skybox image rendering environment, wherein
the indication specifies an object depicted in a two-dimensional (2D) panoramic image as rendered in the skybox image rendering environment, and
the indication specifies a measurement direction;
identifying a start-point (M₁) and an end-point (M₂) in the panoramic image between which the 3D measurement extends by identifying opposite edges representing perimeters, or parts thereof, of the object, wherein
the opposite edges are identified by starting from an initial point in the 2D panoramic image located inside the object and searching in a first direction along the measurement direction until encountering a first point on a first edge of the object and searching in a second direction opposite the measurement direction until encountering a second point on a second edge of the object, and
the first point defines the end-point (M₂) and the second point defines the start-point (M₁); and
determining a distance (dist_{M}) between the start-point (M₁) and the end-point (M₂) as a function of a first depth map corresponding to the start-point (M₁) in the panoramic image and a second depth map corresponding to the end-point (M₂) in the panoramic image.

2. The method of claim 1, wherein
the skybox image rendering environment is obtained from a 3D point cloud.

3. The method of claim 2, wherein
the depth maps are generated from the 3D point cloud.

4. The method of claim 1, wherein
the initial point in the 2D panoramic image is expressed as a coordinate in the 2D panoramic image and is given by the indication for the 3D measurement.

5. The method of claim 1, wherein
the measurement direction is any of: horizontal, vertical, user-defined.

6. The method of claim 1, wherein
the indication specifies two measurement directions, and wherein each of the two measurement directions is associated with its own pair of one start-point and one end-point.

7. The method of claim 6, wherein
the first measurement direction is horizontal and the second measurement direction is vertical.

8. The method of claim 2, wherein
the first direction and the second direction are established from directional vectors in the 3D point cloud and/or directional vectors in the skybox image rendering environment.

9. The method of claim 8, wherein
the first direction and the second direction represent changes in latitude and longitude angles with respect to a default vertically pointing vector and a default horizontally pointing vector in the 3D point cloud.

10. The method of claim 1, wherein
searching in the first direction and searching in the second direction involves establishing a respective parsing direction and performing an edge search along each respective parsing direction.

11. The method of claim 10, wherein
the parsing direction is established by starting from the initial point in the 2D panoramic image to a step-point.

12. The method of claim 10, wherein
the edge search is performed in an edge map by using marching-ray iteration across a 2D image pixel grid of the 2D panoramic image.

13. The method of claim 12, wherein
the edge map is a binary mask containing nonzero-values corresponding to edges in the 2D panoramic image and zero-values corresponding to non-edges in the 2D panoramic image.

14. The method of claim 1, wherein
the method further comprises:
outputting the identified start-point (M₁) and end-point (M₂) before retrieving the first depth map and the second depth map.

15. The method of claim 14, wherein
the method further comprises:
prompting input for acceptance of the identified start-point (M₁) and end-point (M₂) before retrieving the first depth map and the second depth map.

16. The method of claim 14, wherein
the method further comprises:
obtaining adjustment to at least one of the identified start-point (M₁) and end-point (M₂), and wherein the first depth map and the second depth map are retrieved for the identified start-point (M₁) and end-point (M₂) as adjusted.

17. The method of claim 1, wherein
the panoramic image is composed of a set of individual images I_{n,s}={I_{n,-90}, I_{n,0}, I_{n, +90}, I_{n, 180}, I_{n,up}, I_{n,down}}, with one individual image per each side in the skybox image rendering environment, and wherein there is one depth map per each individual image.

18. The method of claim 1, wherein
the method further comprises: outputting the determined distance (dist_{M}).

19. The method of claim 18, wherein
the determined distance (dist_{M}) is output by being provided to a user interface for being displayed to a user.

20. The method of claim 18, wherein
the determined distance (dist_{M}) is output by being provided to an interface of a computer-implemented image processing application.

21. A controller for three-dimensional (3D) measurements in a skybox image rendering environment, the controller comprising:
memory; and
processing circuitry wherein the controller is operable to perform a method comprising:
obtaining an indication for a 3D measurement to be made in the skybox image rendering environment, wherein
the indication specifies an object depicted in a two-dimensional (2D) panoramic image as rendered in the skybox image rendering environment, and
the indication specifies a measurement direction;
identifying a start-point (M₁) and an end-point (M₂) in the panoramic image between which the 3D measurement extends by identifying opposite edges representing perimeters, or parts thereof, of the object, wherein
the opposite edges are identified by starting from an initial point in the 2D panoramic image located inside the object and searching in a first direction along the measurement direction until encountering a first point on a first edge of the object and searching in a second direction opposite the measurement direction until encountering a second point on a second edge of the object, and
the first point defines the end-point (M₂) and the second point defines the start-point (M₁); and
determining a distance (dist_{M}) between the start-point (M₁) and the end-point (M₂) as a function of a first depth map corresponding to the start-point (M₁) in the panoramic image and a second depth map corresponding to the end-point (M₂) in the panoramic image.

22-25. (canceled)
